(19) United States
(12) Patent Application Publication
(10) Pub. No.: US 2015/0382070 A1
(43) Pub. Date: Dec. 31, 2015

(54) METHOD, ELECTRONIC DEVICE, AND COMPUTER PROGRAM PRODUCT

(71) Applicant: Kabushiki Kaisha Toshiba, Tokyo (JP)

(72) Inventors: Shinichiro MANABE, Akishima Tokyo (JP); Shikyo OHASHI, Hino Tokyo (JP); Masahiko OJIMA, Ome Tokyo (JP); Mitsuru SHIMBAYASHI, Nakano Tokyo (JP); Takuya KODA, Hino Tokyo (JP); Tomonori SAKAGUCHI, Ome Tokyo (JP)

(21) Appl. No.: 14/846,640

(22) Filed: Sep. 4, 2015

Related U.S. Application Data
(63) Continuation of application No. PCT/JP2013/075932, filed on Sep. 25, 2013.

(51) Int. Cl. H04N 21/482; G10L 21/10; H04N 21/422; G10L 15/26

(52) U.S. Cl. CPC H04N 21/4828; G10L 15/26; G10L 21/10; H04N 21/42203

(57) ABSTRACT

According to one embodiment, a method by an electronic device includes: receiving audio data including a voice of a user; performing voice recognition to translate the audio data to text including a first character string corresponding to the voice; determining whether the first character string is registered in conversion information; displaying, when the first character string is registered in the conversion information, a second character string associated with the first character string in the conversion information; receiving, when an instruction is received from the user and when the first character string is not registered in the conversion information, a third character string obtained by editing the first character string; and registering, when the third character string is found in program information, the third character string in the conversion information so as to associate the third character string with the first character string.

### CROSS-REFERENCE TO RELATED APPLICATIONS

This application is a continuation of International Application No. PCT/JP2013/075932, filed on Sep. 25, 2013, the entire contents of which are incorporated herein by reference.

### FIELD

Embodiments described herein relate generally to a method, an electronic device, and a computer program product.

### BACKGROUND

In recent years, in television devices equipped with video recording/playback functions or in recording/playback devices, a search function of desired and recorded programs has become increasingly important. Because of this, to avoid troublesomeness due to a key input of a program name or the like, recording/playback devices that can search recorded programs by a user inputting a program name or the like via a remote controller by user's voice have been introduced.

However, in the video recording/playback devices, even if a program name or the like input by voice is accurately recognized, there may be a case in which the program name is not converted to the exact name intended by a user. Accordingly, it is desirable to provide a search that is convenient for a voice input performed by a user and in which a program name can be accurately searched.

### BRIEF DESCRIPTION OF DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating an example of the configuration of a video recording/playback system according to a first embodiment;

FIG. 2 is an exemplary diagram illustrating an example of the hardware configuration of a mobile terminal according to the first embodiment;

FIG. 3 is an exemplary block diagram illustrating an example of the functional configuration of the mobile terminal according to the first embodiment;

FIG. 4 is an exemplary diagram illustrating an example of a conversion DB according to the first embodiment;

FIG. 5 is a flowchart illustrating the procedure of a program search process according to the first embodiment;

FIG. 6 is an exemplary diagram illustrating an example of a menu bar and a voice input screen according to the first embodiment;

FIG. 7 is an exemplary diagram illustrating an example of a candidate confirmation screen according to the first embodiment;

FIG. 8 is a flowchart illustrating the procedure of a program search process according to a second embodiment;

FIG. 9 is a flowchart illustrating the procedure (continued) of the program search process according to the second embodiment;

FIG. 10 is an exemplary diagram illustrating an example of a recognition candidate selection screen according to the second embodiment;

FIG. 11 is a flowchart illustrating the procedure of a program search process according to a third embodiment;

FIG. 12 is a flowchart illustrating the procedure of the program search process according to the third embodiment;

FIG. 13 is an exemplary diagram illustrating an example of the configuration of a video recording/playback system according to a fourth embodiment;

FIG. 14 is an exemplary block diagram illustrating an example of the functional configuration of a mobile terminal according to the fourth embodiment; and

FIG. 15 is a flowchart illustrating the procedure of a program search process according to the fourth embodiment.

### DETAILED DESCRIPTION

In general, according to one embodiment, a method by an electronic device comprises: receiving audio data including a voice of a user; performing voice recognition to translate the audio data to text including a first character string corresponding to the voice; determining whether the first character string is registered in conversion information; displaying, when the first character string is registered in the conversion information, a second character string associated with the first character string in the conversion information; receiving, when an instruction is received from the user and when the first character string is not registered in the conversion information, a third character string obtained by editing the first character string; and registering, when the third character string is found in program information, the third character string in the conversion information so as to associate the third character string with the first character string.

Embodiments will be described below based on the drawings.

### First Embodiment

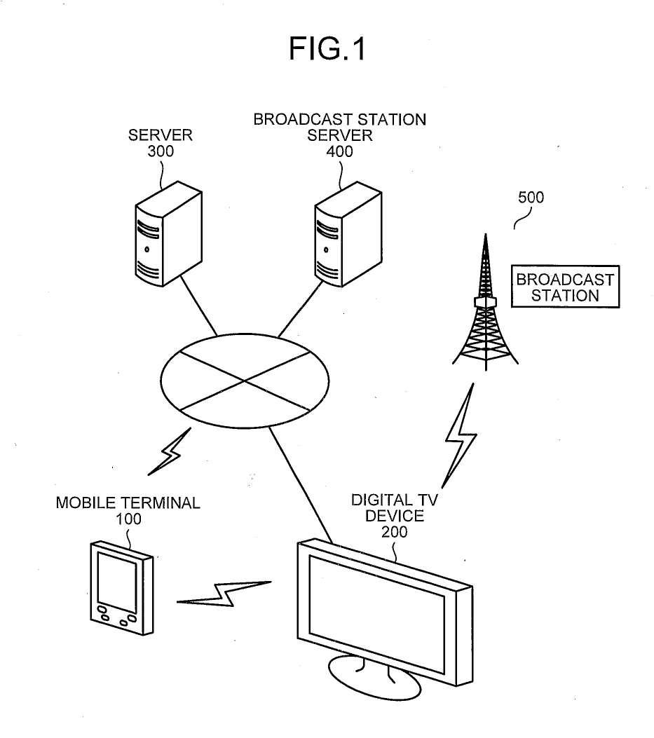

As illustrated in FIG. 1, a video recording/playback system according to a first embodiment is configured such that a mobile terminal 100 is connected to a digital TV device 200 via a wireless network, such as a Wi-Fi (registered trademark) or the like. As illustrated in FIG. 1, the mobile terminal 100 and the digital TV device 200 are connected to a server 300 held by a service vendor or the like on the Internet or a broadcast station server 400. Furthermore, the digital TV device 200 receives broadcast waves sent from a broadcast station 500.

The digital TV device 200 according to the first embodiment has mounted thereon a tuner for receiving signals of digital broadcasting and, furthermore, has a video recording/playback function of broadcast programs. Furthermore, the digital TV device 200 according to the first embodiment has a Web browser function for searching and displaying various sites on the Internet. Furthermore, the digital TV device 200 according to the first embodiment supports Hybridcast (registered trademark); therefore, the digital TV device 200 receives broadcast waves from the broadcast station 500, receives content or an application related to a broadcast program from the broadcast station server 400 or the server 300, and starts up the application or the like, and thereby the digital TV device 200 can display the content coupled with the broadcast program on the broadcast program. Furthermore, the server 300 manages an electronic program guide (EPG).

Furthermore, in the first embodiment, the digital TV device 200 is used as an example of a video recording/playback device; however, the device is not limited thereto as long as the device has a video recording/playback function. For example, a device, such as a hard disc recorder, a set-top box, or the like, that includes a tuner for receiving broadcast waves, that has a video recording/playback function, that processes video images, and that outputs the video images to an externally connected display device may also be used.

The mobile terminal 100 is an electronic device that functions as a remote controller that performs an operation with respect to the digital TV device 200 and is implemented as, for example, a mobile phone, such as a smartphone, a tablet terminal, a slate terminal, or the like. By executing a particular application program, the mobile terminal 100 performs an operation with respect to the digital TV device 200.

Furthermore, the digital TV device 200 according to the first embodiment supports Hybridcast (registered trademark); therefore, by receiving content or an application related to the broadcast program from the broadcast station server 400 or the server 300 and by starting up the application or the like, the digital TV device 200 can display, on a broadcast program, content that is coupled with the broadcast program that is being broadcast by the digital TV device 200.

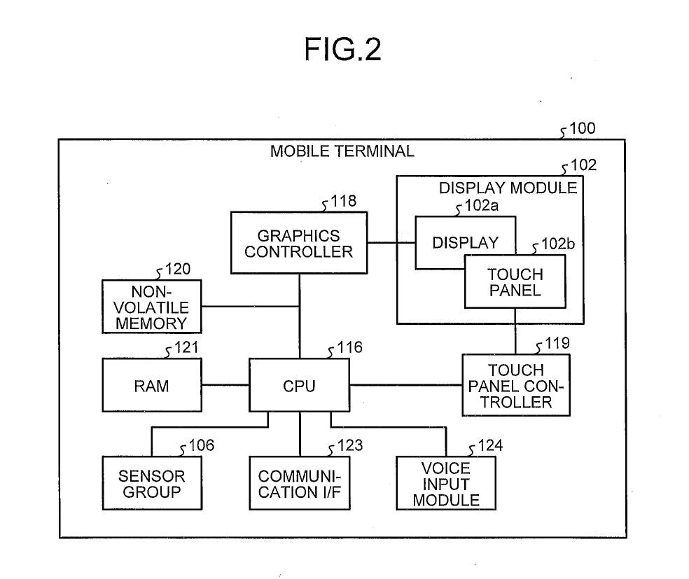

As illustrated in FIG. 2, the mobile terminal 100 comprises a display module 102, a central processing unit (CPU) 116, a graphics controller 118, a touch panel controller 119, a nonvolatile memory 120, a random access memory (RAM) 121, a communication I/F 123, a sensor group 106, a voice input module 124, and the like. In addition to these, the mobile terminal 100 may also comprise a camera, a speaker, and the like.

The voice input module 124 is a voice input device, such as a microphone or the like, and inputs a voice output from a user. In the first embodiment, the voice input module 124 receives, via the user's voice, an input text of an instruction to search a program name or an instruction to operate the digital TV device 200.

The display module 102 is configured as a so-called touch screen that is a combination of a display 102a and a touch panel 102b. The display 102a is, for example, a liquid crystal display (LCD), an organic electro luminescence (EL) display, or the like. The touch panel 102b detects a position (touch position) on a display screen of the display 102a touched by a user's finger, a stylus pen, or the like.

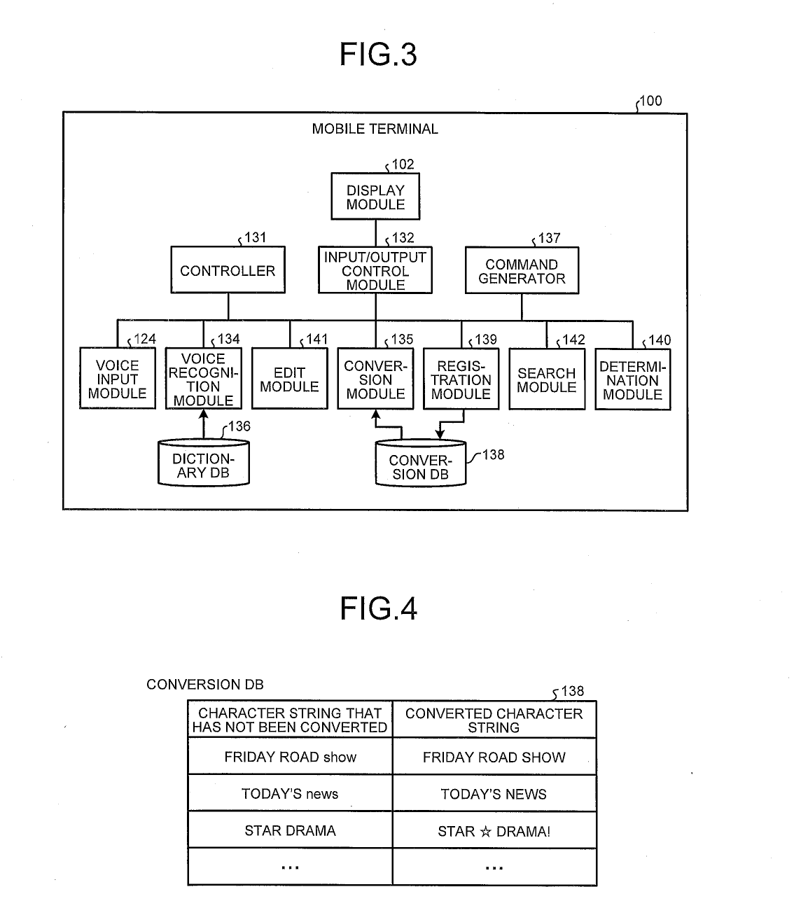

The nonvolatile memory 120 stores therein an operating system, various application programs, various kinds of data needed to perform the programs, or the like. The CPU 116 is a processor that controls an operation of the mobile terminal 100 and controls each of the components in the mobile terminal 100. By executing various application programs including the operating system and command generating applications loaded in the RAM 121 from the nonvolatile memory 120, the CPU 116 implements each of the function modules (see FIG. 3), which will be described later. The RAM 121 provides, as a main memory of the mobile terminal 100, a work area that is used when the CPU 116 executes a program.

The graphics controller 118 is a display controller that controls the display 102a in the display module 102. The touch panel controller 119 controls the touch panel 102b and acquires, from the touch panel 102b, coordinate data that indicates a touch position touched by a user.

The communication I/F 123 performs, under the control of the CPU 116, wireless communication with an external device, such as the digital TV device 200, or the like or communication via a network, such as the Internet, or the like.

The sensor group 106 is an acceleration sensor that detects a direction and a magnitude of external acceleration with respect to the mobile terminal 100, an orientation sensor that detects an orientation of the mobile terminal 100, a gyro sensor that detects an angular velocity (rotation angle) of the mobile terminal 100, or the like. A detection signal of each of the sensors is output to the CPU 116.

The mobile terminal 100 implements each of the modules illustrated in FIG. 3 by working in cooperation with programs (various application programs, such as the operating system, a program search application program, or the like) stored in the CPU 116 and the nonvolatile memory 120.

As illustrated in FIG. 3, the mobile terminal 100 according to the first embodiment comprises, as the functional configuration, a controller 131, an input/output control module 132, a voice recognition module 134, a conversion module 135, a command generator 137, an edit module 141, a registration module 139, a determination module 140, a search module 142, a dictionary database 136, and a conversion database 138.

Here, FIG. 3 also illustrates the voice input module 124 and the display module 102 that have been described above. Here, the dictionary database 136 and the conversion database 138 are stored in a storage medium, such as a hard disk drive device (HDD), a memory, or the like.

The dictionary database 136 (hereinafter, referred to as a “dictionary DB 136”) is a database in which various kinds of words are registered and that is referred to when a voice recognition process is performed by the voice recognition module 134. Instead of disposing the dictionary DB 136 in the mobile terminal 100, the dictionary DB may also be alternately disposed in the server 300 and voice recognition may also be performed on the server 300 side.

The controller 131 performs the overall control of the mobile terminal 100. The voice recognition module 134 performs, by using the dictionary DB 136, a voice recognition process or morphological analysis on voice data of an input text described in a natural language that was input, via a voice, to the voice input module 124 and then outputs a character string of the input text as the result of the recognition result.

The input/output control module 132 controls an input/output with respect to the display module 102. Namely, the input/output control module 132 performs display control on the display 102a in the display module 102 via the graphics controller 118 and controls an input received by a touch operation performed on the touch panel 102b in the display module 102 via the touch panel controller 119. The input/output control module 132 according to the first embodiment displays, on the display 102a in the display module 102, a character string obtained as the recognition result by the voice recognition module 134.

The command generator 137 generates a command including a character string recognized, by the voice recognition module 134, from voice of an operation instruction that is related to the digital TV device 200 and that is input by a user from the voice input module 124.

Furthermore, the communication I/F 123 illustrated in FIG. 2 sends the command generated by the command generator 137 to the digital TV device 200. The digital TV device 200 receives the subject command and interprets the command. Then, an operation in accordance with the operation instruction is performed. Furthermore, the communication I/F 123 illustrated in FIG. 2 sends and receives various kinds of data via the Internet.

The conversion database 138 (hereinafter, referred to as a “conversion DB 138”) is a database in which a character string (a first character string) that is the result of the voice recognition performed by the voice recognition module 134 and that has not been converted is associated with a character string that was obtained from the character string edited by a user. Even if a character string in which a voice input that was output from a user is correctly recognized by the voice recognition module 134, there may be a case in which a program name intended by the user is not displayed. In such a case, the user edits the character string (i.e., a character string associated with a user's voice) obtained as the recognition result to a desired program name; associates, as a converted character string, the edited character string with a character string (a first character string) that is obtained as the recognition result and that has not been converted; and registers the associated character strings in the conversion DB 138. The registration to the conversion DB 138 will be described in detail later.

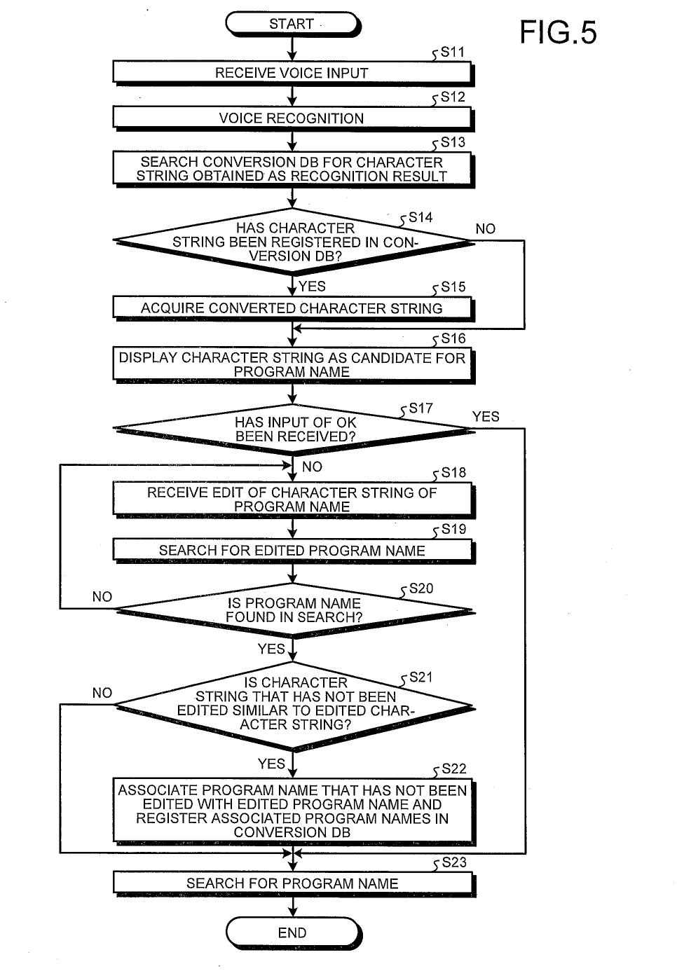

As illustrated in FIG. 4, in the conversion DB 138, the character string (the first character string) that has not been converted and the character string (a second character string) that has been converted are registered in an associated manner. In the example illustrated in FIG. 4, the character string of “Friday road show” that has not been converted and the character string of “Friday road SHOW” that has been converted are associated with each other and registered. In this example, even if an English character is present in a part of the program name, in a speech, it is difficult to distinguish between “show” and “SHOW”. Accordingly, in a case in which a user outputs a speech of “Friday road show” and then obtains “Friday road show” as the result of the voice recognition of that speech, if a character string of the program name that is present and that is actually intended by the user is “Friday road SHOW”, an accurate program name can be obtained if the character string of “Friday road SHOW” is registered in the conversion DB 138.

Furthermore, in the conversion DB 138 illustrated in FIG. 4, character string “star drama” that has not been converted is associated with the converted character string “star * drama!” and the associated character strings are registered. In the program name, in this way, symbols, such as “*”, “!”, or the like are often included and thus it is difficult for a user to output the symbol via the User's voice. Consequently, a program name is not able to be accurately recognized only from the voice recognition. Thus, in the first embodiment, a program name that includes a symbol is registered as the character string that is obtained by converting, and is associated with a character string that is recognized as voice recognition on the basis of user's voice of a character string from which a symbol included in the program name is excluded, which is registered as a character string that has not been converted. The examples illustrated in FIG. 4 are not limited thereto.

The conversion module 135 determines whether the character string, which is the recognition result obtained by the voice recognition module 134, has been registered as the character string that has not been converted in the conversion DB 138. If the target character string has been registered, the conversion module 135 converts this character string to a converted character string (the second character string) that is associated with the subject character string stored in the conversion DB 138. For example, in the example illustrated in FIG. 4, even if voice is output as “today's news” and is recognized as “today's news” in the voice recognition, the conversion module 135 refers to the conversion DB 138 and converts “today's news” to “today's NEWS” that is the accurate program name. Accordingly, if a converted character string has already been registered, the conversion module 135 can convert, to an accurate program name, the character string in which voice recognition has been performed from the voice input received from a user.

If a character string (the first character string) that is obtained as the result of the voice recognition has not been registered in the conversion DB 138 as a character string that has not been converted and if the character string that is obtained as the recognition result displayed on the display 102a is a character string of a program name or the like that is not intended by the user, the user performs, via the touch panel 102b, an edit operation on the character string that is obtained as the recognition result. The edit module 141 receives an edit of the character string that is the recognition result and then edits the character string.

The search module 142 performs a program search by using a program name designated by a user. Furthermore, by using a character string (a third character string) edited by the edit module 141 as a search key, the search module 142 searches, via the communication I/F 123, for information on an electronic program guide (EPG) in the an external device, such as the server 300, in the network or information on programs of a moving image shared site or the like and then receives, from the external device, the search result indicating whether the program name that matches the character string which is found in the search.

The determination module 140 determines, on the basis of the number of edited characters, whether the character string obtained from the recognition result, i.e., character string that has not been edited (the first character string), is similar to the character string edited by the edit module 141 (the third character string). Specifically, if the number of edited characters is, for example, equal to or less than a certain number of characters, such as 5 characters, the determination module 140 determines that the character string that has not been edited is similar to the edited character string. Alternatively, the determination module 140 may also be configured to determine, when the ratio of the number of edited characters to all of the number of characters in the character string that has not been edited or to all of the number of characters in the character string that has been edited is equal to or less than a certain ratio, for example, 20%, that the character string that has not been edited is similar to the character string that has been edited. However, the reference of determining the similarity is not limited thereto.

If it is determined, from the search result received by the search module 142, that the program name that matches the edited character string which is found in the search and if it is determined, by the determination module 140, that the character string that has not been edited is similar to the edited character string, the registration module 139 sets the edited character string (the third character string) as a converted character string; sets the character string that has not been edited (the first character string) as a character string that has not been converted; associates both the character strings; and registers the associated character strings in the conversion DB 138, thereby allowing a character string with the correct program name to be learned.

In the following, a program search process performed by the mobile terminal 100 according to the first embodiment having the configuration described above will be described with reference to FIG. 5.

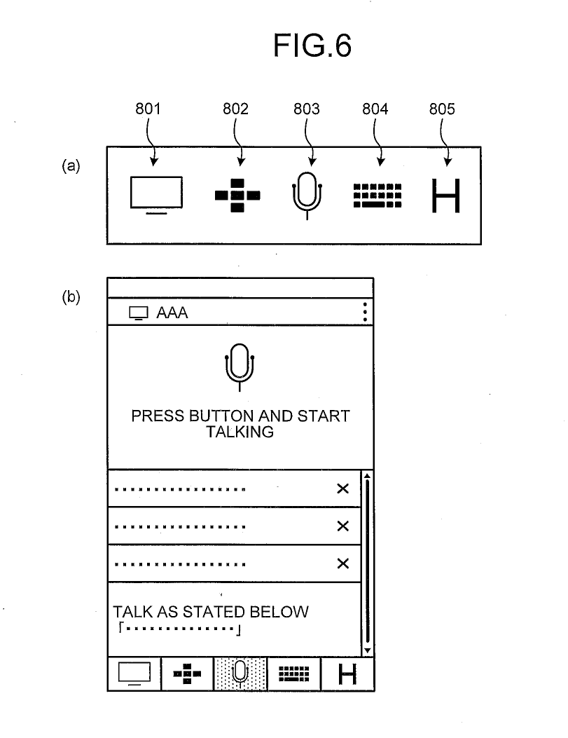

First, the input/output control module 132 in the mobile terminal 100 displays a menu bar on the lower portion of the screen displayed on the display 102a. The menu bar is illustrated in (a) of FIG. 6. On the menu bar, five 5 keys (buttons) are displayed. The key with a code 801 is a key that is used to start up a current program guide that is the list of programs that are currently being broadcast. The key with a code 802 is a key that is used to start up a remote controller detailed screen. The key with a code 803 is a key that is used to start up a voice input screen. The key with a code 804 is a key that is used to start up a text input screen. The key with a code 805 is a key that is used to start up a Hybridcast (registered trademark) cooperative function.

If a user presses the key with the code 803 illustrated in (a) of FIG. 6, the input/output control module 132 displays, on the display 102a in response to pressing of the key, the voice input screen illustrated in (b) of FIG. 6 and the processes indicated by the flowchart illustrated in FIG. 5 are performed. If a user inputs, on the voice input screen illustrated in (b) of FIG. 6, a voice input of a program name to be searched, the voice input module 124 receives the subject voice input (S11).

Then, the voice recognition module 134 performs a voice recognition process on the voice indicating the program name that has been input by the voice input module 124 (S12) and then outputs a character string that is obtained as the recognition result. Thereafter, the conversion module 135 extracts, from the character string output from the voice recognition module 134, the character string of the program name that is obtained as the recognition result; searches the conversion DB 138 for the subject character string (S13); and determines whether the character string obtained as the recognition result has been registered in the conversion DB 138 as the character string that has not been converted (S14).

If the character string obtained as the recognition result has been registered in the conversion DB 138 (Yes at S14), the conversion module 135 acquires a converted character string that is associated with the character string obtained as the recognition result and that is stored in the conversion DB 138, whereby the conversion module 135 converts the character string (S15). In contrast, at S14, if the character string obtained as the recognition result has not been registered in the conversion DB 138 (No at S14), the process at S15 is not performed.

Then, the input/output control module 132 displays, on the display 102a in the display module 102 as a candidate for the program name, the character string obtained as the recognition result if No is indicated at S14 and a converted character string if Yes is indicated at S14 (S16). Specifically, the input/output control module 132 displays, on the display 102a, a candidate confirmation screen that is used to check with a user whether the above described character string is appropriate for a candidate for the program name.

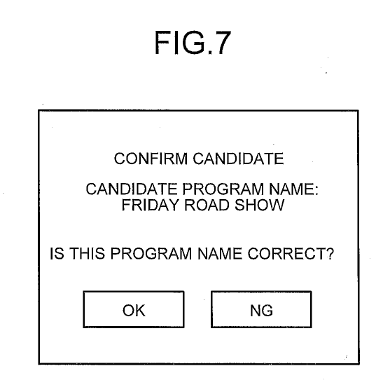

As illustrated in FIG. 7, on the candidate confirmation screen, the character string “Friday road show”, which has been obtained as the recognition result by the voice recognition module 134 and which is as a candidate program name, and a message that is used to check whether this program name is correct, i.e., whether the character string is intended by a user, are displayed. Then, an OK button and an NG button that are used to allow the user to input a response with respect to the subject inquiry are displayed on the candidate confirmation screen.

If the user presses the OK button on this candidate confirmation screen and if the input/output control module 132 receives an input of an event of OK (Yes at S17), this indicates that the program name displayed as the candidate is intended by the user. Consequently, the search module 142 performs a program search by using the program name of that candidate (S23).

In contrast, at S17, if the user presses the NG button on this candidate confirmation screen and if the input/output control module 132 does not receive an input of the event of OK (No at S17), this indicates that the program name displayed as the candidate is not intended by the user. Consequently, the user performs an edit operation of a character string via the touch panel 102b and, then, the edit module 141 receives the subject edit operation and edits the candidate character string (S18).

Then, the search module 142 searches, by using the program name in the edited character string, an EPG in the server 300, a moving image shared site, or the like (S19) and receives a search result. Then, the search module 142 determines whether the search result indicates that the program name in the edited character string is found in the search (S20). If the search result does not indicate that the program name in the edited character string is found in the search (No at S20), the process returns to S18 and then an edit of the character string to be performed by the user is received (S18).

In contrast, if the search result indicates that the program name in the edited character string is found in the search (Yes at S20), the determination module 140 determines whether the character string that has not been edited is similar to the edited character string (S21). Here, the reference of determining the similarity is the same as that described above.

Then, if the determination module 140 determines that the character string that has not been edited is similar to the edited character string (Yes at S21), the registration module 139 sets the character string that has not been edited as a character string that has not been converted, sets the edited character string as a converted character string, associates both the character strings, and registers the associated character strings in the conversion DB 138 (S22). At S21, if the determination module 140 determines that the character string that has not been edited is not similar to the edited character string (No at S21), the registration process with respect to the conversion DB 138 at S22 is not performed. Then, the search module 142 performs a program search by using the program name in the edited character string (S23).

As described above, in the first embodiment, if a program name received as a voice input from a user and if the character string subjected to voice recognition has been registered in the conversion DB 138, the subject character string is converted to a program name in the converted character string that is associated with the subject character string in the conversion DB 138 and then the program name is searched. Furthermore, in the first embodiment, if the character string that has been recognized as the character string that has not been converted in the conversion DB 138 is not registered and if an instruction is received from a user, an edit of the recognized character string performed by the user is received. In the first embodiment, for the edited character string, a search is performed on the server 300, a moving image shared site, or the like in a network and, if an edited character string is found in the search, the character string that has not been edited is set as a character string that has not been converted; the edited character string is set as the converted character string; and both the character strings are registered in the conversion DB 138 in an associated manner. Consequently, according to the first embodiment, a voice input is convenient for a user and, furthermore, a search for an accurate program name can be implemented.

Furthermore, in the first embodiment, if a character string that has been subjected to voice recognition is edited by a user and if the edited character string is found in the search from the server 300, the moving image shared site, or the like in a network, the determination module 140 checks the similarity between the character string that has not been edited and the edited character string. If both the character strings are similar, the character string that has not been edited is set as the character string that has not been converted, the edited character string is set as the converted character string, and both the character strings are associated with each other and registered in the conversion DB 138, whereby learning is performed. Consequently, when a program name received as a voice input is significantly incorrect and is greatly edited, it is possible for a user to further enhance convenience by avoiding registration in the conversion DB 138, preventing a conversion error, and improving the accuracy.

Furthermore, in the first embodiment, if a user edits a recognized character string, the server 300 or the moving image shared site in a network is searched by using a program name in the edited character string; however, the method is not limited thereto. For example, even if a user inputs OK at S17 and the recognized character string is not edited by the user, the search module 142 may also be configured such that the server 300 or the moving image shared site in the network is searched by using the program name in the recognized character string. In this case, if the program name in the recognized character string is not searched, the edit module 141 may also be configured such that a user edits the character string.

### Second Embodiment

In the first embodiment, if a character string obtained as the result of the voice recognition is edited by a user, the character string that has not been edited is associated with the edited character string and the associated character strings are registered in the conversion DB 138. However, in a second embodiment, if a character string that is as a candidate is selected by a user in addition to the character string obtained as the recognition result when the voice recognition is performed, the character string obtained as the recognition result is associated with the character string that is selected by the user and that becomes the candidate and then the associated character strings are registered in the conversion DB 138.

The network configuration of a video recording/playback system and the hardware configuration and the functional configuration of the mobile terminal 100 according to the second embodiment are the same as those described in the first embodiment.

When the input/output control module 132 according to the second embodiment displays, on the display 102a in the display module 102, the result of voice recognition performed by the voice recognition module 134, the input/output control module 132 displays, in addition to the recognized character string, as the result of the voice recognition, one or a plurality of candidate character strings that become a candidate in a selectable manner.

The registration module 139 according to the second embodiment has the same function as that performed in the first embodiment. Furthermore, if a user selects a desired candidate character string from among one or a plurality of candidate character strings displayed on the display 102a, the registration module 139 according to the second embodiment sets the recognized character string as the character string that has not been converted, sets the selected candidate character string as the converted character string, associates both the character strings, and registers the associated character strings in the conversion DB 138.

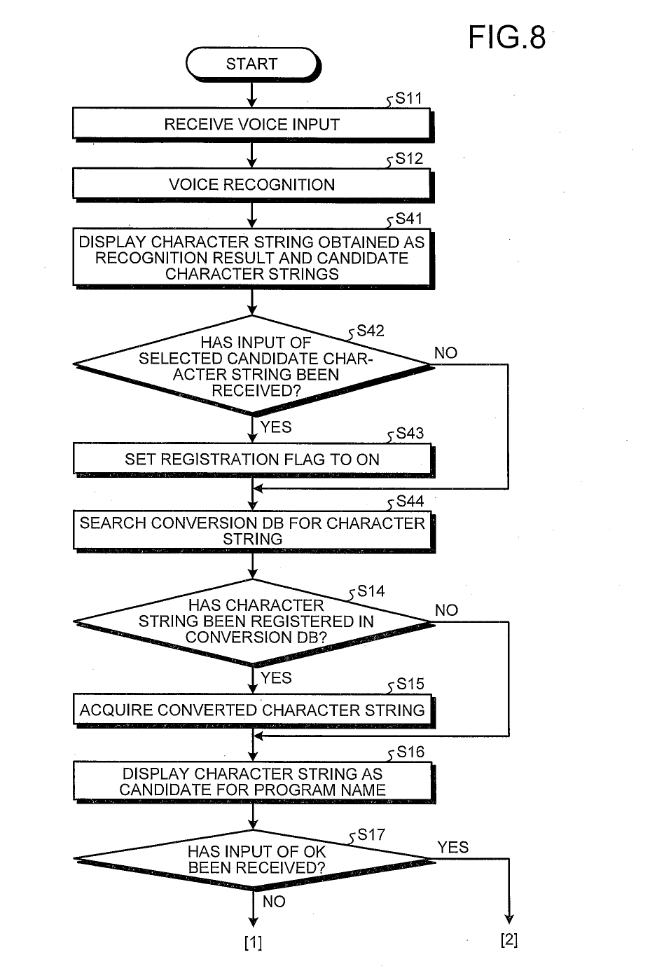

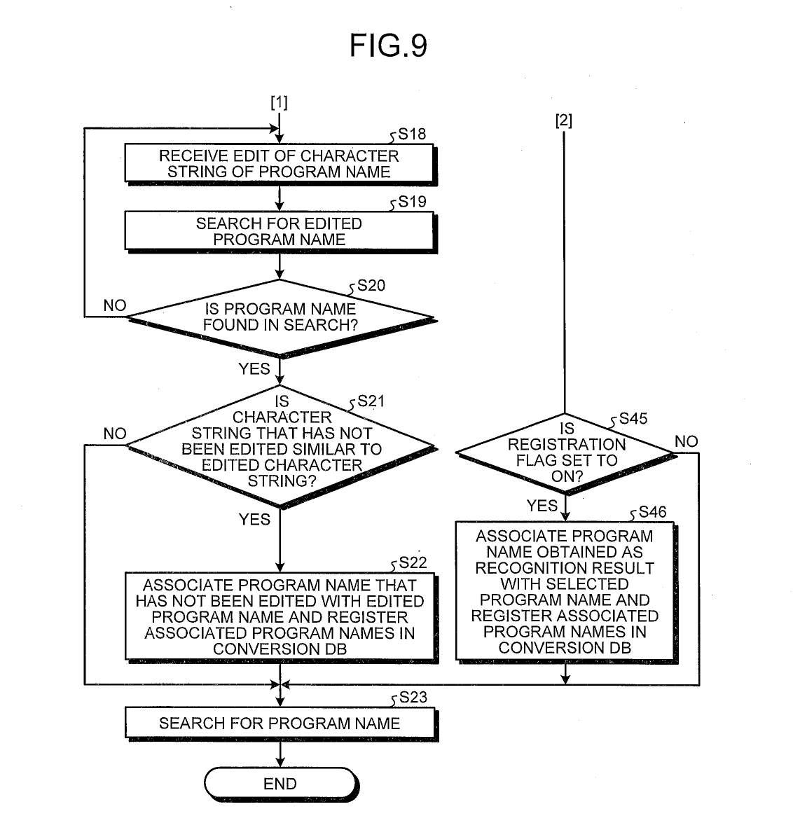

In the following, a program search process according to the second embodiment configured in this way will be described with reference to FIGS. 8 and 9.

Similarly to the first embodiment, the voice input module 124 receives a voice input performed by a user (S11). Then, the voice recognition module 134 performs a voice recognition process on the voice of the program name that is input by the voice input module 124 (S12) and outputs a character string obtained as the recognition result and candidate character strings that are one or a plurality of character strings and that become candidates when the voice recognition process is performed. Then, the input/output control module 132 displays, on the display 102a, a recognition candidate selection screen that indicates, in a selectable manner, the character string obtained as the recognition result and one or the plurality of the candidate character strings (S41). Then, the input/output control module 132 determines, on this recognition candidate selection screen, whether an input of a selected candidate character string has been received from a user (S42).

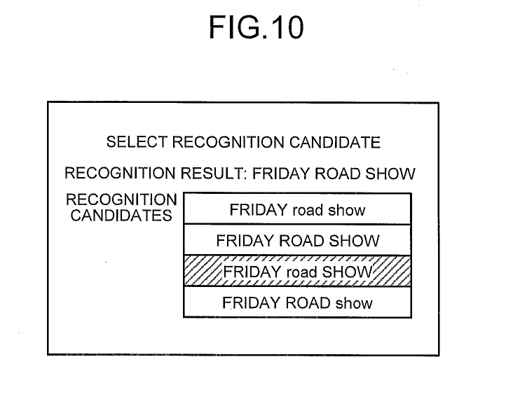

FIG. 10 illustrates an example of a recognition candidate selection screen according to the second embodiment. The example illustrated in FIG. 10 indicates a case in which the character string indicated by “Friday road show” obtained as the result of the voice recognition and four candidate character strings are displayed and the candidate character string indicated by “Friday road SHOW” has been selected by a user.

A description will be given here by referring back to FIG. 8. At S42, if the input/output control module 132 receives a selection of a candidate character string from a user (Yes at S42), the input/output control module 132 sets the selected candidate character string as the program name and sets a registration flag to ON (S43). The registration flag mentioned here is a flag that indicates whether, if an edit operation of a character string is not performed by a user, registration into the conversion DB 138 is performed and, if a flag is set to ON, the registration into the conversion DB 138 is performed. Furthermore, the registration flag is initialized to OFF.

In contrast, at S42, if the input/output control module 132 does not receive a selection of a candidate character string from a user (No at S42), the input/output control module 132 sets the character string, which is obtained as the recognition result from the voice recognition, as a program name as indicated by the recognition result and the process at S43 is not performed.

Then, the conversion module 135 searches the conversion DB 138 for the character string that is set as the program name (S44) and determines whether the character string that has been set as the program name has been registered in the conversion DB 138 as the character string that has not been converted (S14).

If the character string that is set as the program name has been registered in the conversion DB 138 (Yes at S14), by acquiring the converted character string that is associated with the character string of the program name in the conversion DB 138, the conversion module 135 converts the character string (S15). In contrast, at S14, if the character string that is set as the program name has not been registered in the conversion DB 138 (No at S14), the process at S15 is not performed.

Then, the input/output control module 132 displays, on the display 102a as a candidate for the program name, the same candidate confirmation screen as that used in the first embodiment indicating the character string that is set as the program name if No is indicated at S14 and indicating a converted character string if Yes is indicated at S14 (S16).

When a user presses NG on this candidate confirmation screen, if the input/output control module 132 does not receive an input of an event of OK (No at S17), the same processes as those performed in the first embodiment are performed (S18 to S23).

In contrast, at S17, when a user presses OK on this candidate confirmation screen, if the input/output control module 132 receives an input of an event of OK (Yes at S17), this indicates that the program name displayed as a candidate is intended by the user; however, the registration module 139 determines whether the registration flag is set to ON (S45).

If the registration flag is set to ON (Yes at S45), this indicates that the character string obtained as the recognition result performed at S12 is not used as the program name and indicates that the candidate character string is used by a user as the program name at S42. Consequently, the registration module 139 sets the character string obtained as the recognition result at S12 as the character string that has not been converted, sets the candidate character string selected at S42 as the converted character string, associates both the character strings, and registers the associated character strings in the conversion DB 138 (S46). Then, the search module 142 performs a program search by using the program name in the selected candidate character string (S23).

In contrast, at S45, if the registration flag is not set to ON (No at S45), the process at S46 is not performed and the search module 142 performs a program search by using the recognized character string (S23).

As described above, in the second embodiment, in addition to the character string obtained as the recognition result when the voice recognition is performed, if a character string that becomes a candidate is selected by a user, because learning is performed by associating the character string obtained as the recognition result with the character string that has been selected by a user and that becomes a candidate and by registering the associated character strings in the conversion DB 138, it is possible to increase the number of timings of the learning for the conversion DB 138 and thus it is possible for a user to further enhance the convenience.

Furthermore, for example, the determination module 140 and the registration module 139 may also be configured such that, if the registration flag is set to ON at S45, the similarity between the character string obtained as the recognition result and the candidate character string selected by a user is determined and, if both the character strings are similar, the character string obtained as the recognition result is associated with the character string that is selected by a user and that becomes a candidate and the associated character strings are registered in the conversion DB 138.

Furthermore, the search module 142 and the registration module 139 may also be configured such that, if the registration flag is set to ON at S45, the server 300 or the moving image shared site in the network is searched by using the program name in the candidate character string selected by a user and, if the target is found in the search, the character string obtained as the recognition result is associated with the character string that has been selected by a user and that becomes a candidate and then the associated character strings are registered in the conversion DB 138. In this case, if the program name in the candidate character string is not searched, the edit module 141 can be configured to allow a user to edit the character string.

### Third Embodiment

In the first embodiment, if a character string obtained as the result of voice recognition is edited by a user, the character string that has not been edited is associated with the edited character string and the associated character strings are registered in the conversion DB 138. However, in a third embodiment, after a user outputs voice and performs a voice input, if the user again outputs voice and performs a voice input within a regular time period, a character string obtained as the recognition result of a first voice input is associated with a character string obtained as the recognition result of a second voice input and the associated character strings are registered in the conversion DB 138.

The network configuration of the video recording/playback system and the hardware configuration and the functional configuration of the mobile terminal 100 according to the third embodiment are the same as those described in the first embodiment.

The registration module 139 according to the third embodiment has the same function as that performed in the first embodiment. Furthermore, after a voice input due to a voice output from a user is received by the voice input module 124, if the user again outputs voice within a regular time period (for example, within 20 seconds or the like) and receives a second voice input, the registration module 139 according to the third embodiment associates the character string obtained as the result of the voice recognition of a first input voice with the character string obtained as the voice recognition of a second input voice performed by the voice recognition module 134 and then registers the associated character strings in the conversion DB 138.

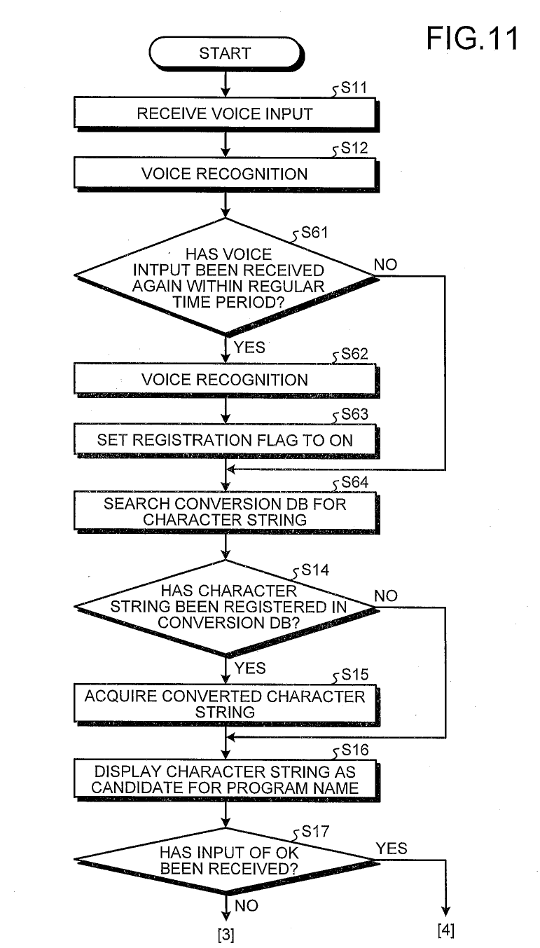

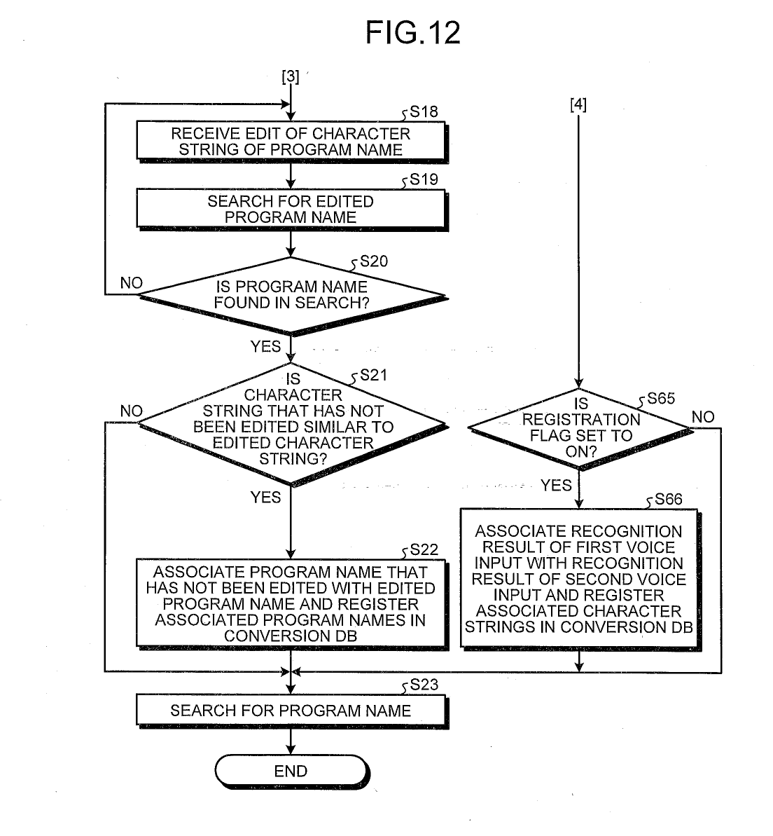

In the following, a program search process according to the third embodiment configured in this way will be described with reference to FIGS. 11 and 12.

Similarly to the first embodiment, the voice input module 124 receives a voice input performed by a user (S11) and the voice recognition module 134 performs a voice recognition process with respect to the voice of the program name that is input by the voice input module 124 (S12) and outputs a character string obtained as the recognition result. Then, after that, if a user again outputs voice within a regular time period and the voice input module 124 again receives a voice input (Yes at S61), the voice recognition Module 134 performs the voice recognition process on the voice of a second input (S62) and again outputs a character string obtained as the recognition result. Then, the controller 131 sets the registration flag to ON (S63). The registration flag mentioned here is the same as that described in the second embodiment.

In contrast, at S61, if the voice input module 124 does not receive a voice input, within a regular time period, that was output second time (No at S61), i.e., if a user does not again output a voice within a regular time period, the processes at S62 and S63 are not performed.

Then, the conversion module 135 searches the conversion DB 138 for the character string obtained as the first or the second recognition result (S64) and determines whether the character string obtained as the recognition result has been registered as the character string that has not been converted in the conversion DB 138 (S14).

If the character string obtained as the recognition result has been registered in the conversion DB 138 (Yes at S14), the conversion module 135 converts the character string by acquiring the converted character string that is obtained as the recognition result and that is associated with the character string in the conversion DB 138 (S15). In contrast, at S14, if the character string obtained as the recognition result has not been registered in the conversion DB 138 (No at S14), the process at S15 is not performed.

Then, the input/output control module 132 displays, on the display 102a as a candidate for the program name, the same candidate confirmation screen as that used in the first embodiment indicating the character string that is obtained as the recognition result if No is indicated at S14 and indicating a converted character string if Yes is indicated at S14 (S16).

When a user presses NG on this candidate confirmation screen, if the input/output control module 132 does not accept an input of an event of OK (No at S17), the same processes as those performed in the first embodiment are performed (S18 to S23).

In contrast, at S17, when a user presses OK on this candidate confirmation screen, if the input/output control module 132 accepts an input of an event of OK (Yes at S17), this indicates that the program name displayed as a candidate is intended by the user; however, the registration module 139 determines whether the registration flag is set to ON (S65).

If the registration flag is set to ON (Yes at S65), this indicates that the user re-outputs the program name. Consequently, the registration module 139 sets the character string, which is obtained from a first input voice performed at S12 as the recognition result, as a character string that has not been converted, sets the character string, which is obtained from a second input voice performed at S62 as the recognition result, as a converted character string, associates both the character strings, and registers the associated character strings in the conversion DB 138 (S66). Then, the search module 142 performs a program search by using the program name in the character string obtained from the second input voice (S23).

In contrast, at S65, if the registration flag is not set to ON (No at S65), the process at S66 is not performed and the search module 142 performs a program search by using the character string obtained from the first input voice (S23).

As described above, in the third embodiment, after a user outputs a voice and performs a voice input, if the user again outputs a voice and performs a voice input within a regular time period, because learning is performed by associating a character string obtained from a first voice input as the recognition result with the character string obtained from a second voice input as the recognition result and by registering the associated character strings in the conversion DB 138, it is possible to increase the number of timings of the learning for the conversion DB 138 and thus it is possible for a user to further enhance convenience.

Furthermore, for example, the determination module 140 and the registration module 139 may also be configured such that, if the registration flag is ON at S65, the similarity between the character string obtained from a first input voice as the recognition result and the character string obtained from a second input voice as the recognition result is determined and, if both the character strings are similar, the character string obtained from the first input voice is associated with the character string obtained from the second input voice and the associated character strings are registered in the conversion DB 138.

Furthermore, the search module 142 and the registration module 139 may also be configured such that, if the registration flag is ON at S65, the server 300 or the moving image shared site in the network is searched by using the program name in the character string obtained from the second input voice as the recognition result and, if the target is found in the search, the character string obtained from the first input voice is associated with the character string obtained from the second input voice and the associated character strings are registered in the conversion DB 138. In this case, if the program name of the character string obtained from the second input voice is not searched, the edit module 141 can be configured to allow a user to edit the character string.

### Fourth Embodiment

In the first to the third embodiments, both the voice recognition and the conversion process performed on a character string using the conversion DB 138 are performed on the mobile terminal 100 side; however, in a fourth embodiment, the voice recognition is performed in a server in a network, a conversion DB is provided in the server in the network, and the conversion process is performed in the server.

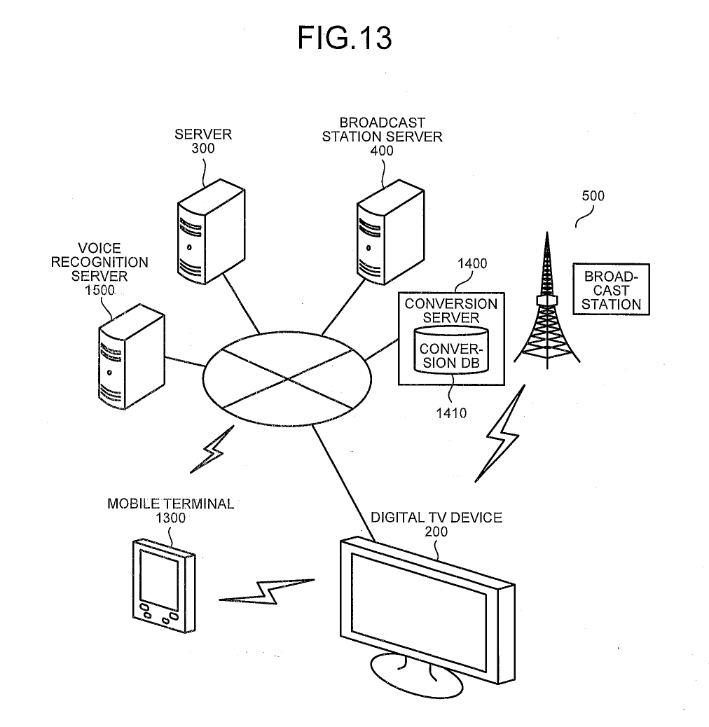

As illustrated in FIG. 13, a video recording/playback system according to the fourth embodiment is configured such that a mobile terminal 1300 is connected to the digital TV device 200 via a wireless network, such as a Wi-Fi (registered trademark) or the like. Furthermore, as illustrated in FIG. 13, the mobile terminal 1300 and the digital TV device 200 are connected to the server 300 held by a service vendor or the like on the Internet, the broadcast station server 400, a voice recognition server 1500, and a conversion server 1400.

The function performed by each of the digital TV device 200, the broadcast station server 400, and the server 300 is the same as that described in the first embodiment. The voice recognition server 1500 has the same dictionary DB (not illustrated) as that used in the first embodiment, receives a voice recognition request together with voice data via the Internet, performs a voice recognition process on the received voice data, and sends a character string obtained as the recognition result to the transmission source of the voice recognition request. In the fourth embodiment, the mobile terminal 1300 sends the voice recognition request together with the voice data to the voice recognition server 1500.

The conversion server 1400 has a conversion DB 1410. The conversion DB 1410 is shared by a plurality of the mobile terminals 1300 and has the same data structure as the conversion DB 138 in the first embodiment illustrated in FIG. 4. The conversion server 1400 receives a conversion request together with a character string via the Internet. Then, the conversion server 1400 determines whether the received character string has been registered in the conversion DB 1410 as the character string that has not been converted and sends, if the received character string has been registered, a converted character string associated with the received character string in the conversion DB 1410 to the transmission source of the conversion request. In contrast, if the received character string has not been registered in the conversion DB 1410 as the character string that has not been converted, the conversion server 1400 sends, to the transmission source of the conversion request, information indicating that the character string is not registered in the conversion DB 1410. In the fourth embodiment, the mobile terminal 1300 sends the conversion request together with the character string obtained from a voice input to the conversion server 1400.

In the following, the mobile terminal 1300 will be described. The configuration of the mobile terminal 1300 according to the fourth embodiment is the same as that described in the first embodiment with reference to FIG. 2.

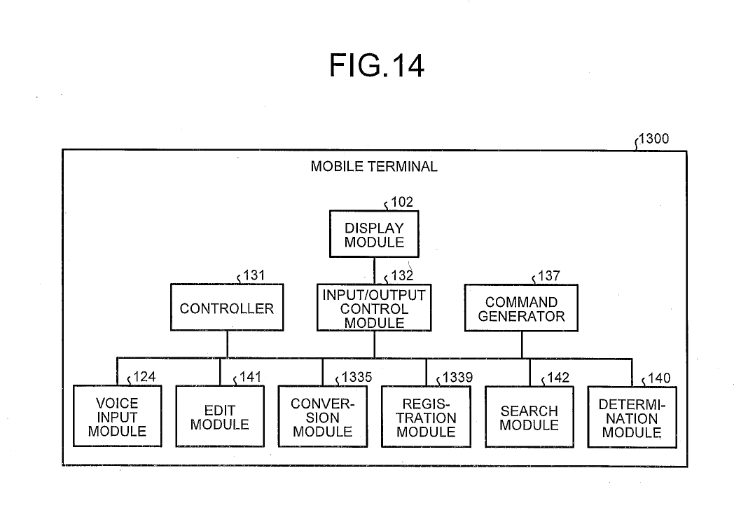

As illustrated in FIG. 14, the mobile terminal 1300 according to the fourth embodiment comprises, as the functional configuration, the controller 131, the input/output control module 132, a conversion module 1335, the command generator 137, the edit module 141, a registration module 1339, the determination module 140, and the search module 142. FIG. 14 also illustrates the voice input module 124 and the display module 102. Unlike the first embodiment, in the mobile terminal 1300 according to the fourth embodiment, a dictionary DB, a conversion DB, and a voice recognition module are not provided. Here, the function performed by each of the controller 131, the input/output control module 132, the command generator 137, the edit module 141, the determination module 140, and the search module 142 is the same as that described in the first embodiment.

Furthermore, the controller 131 sends voice data of voice that is input from the voice input module 124, sends a voice recognition request to the voice recognition server 1500, and receives a character string obtained as the recognition result from the voice recognition server 1500. The controller 131 outputs the received character string obtained as the recognition result to the conversion module 1335.

The conversion module 1335 sends, to the conversion server 1400 via the communication I/F 123, a conversion request together with the character string that is obtained as the recognition result and receives, from the conversion server 1400, a determination result indicating whether the character string targeted for the conversion request has been registered in the conversion DB 1410. Specifically, if a character string targeted for the conversion request has been registered in the conversion DB 1410, the conversion module 1335 receives, as the determination result from the conversion server 1400, both the converted character string and the information indicating that the character string targeted for the conversion request has been registered in the conversion DB 1410. In contrast, if the character string targeted for the conversion request has not been registered in the conversion DB 1410, the conversion module 1335 receives, from the conversion server 1400, the determination result indicating that the character string targeted for the conversion request is not registered in the conversion DB 1410. The conversion module 1335 and the communication I/F 123 are examples of a communication module.

If it is determined, from the received search result, that the program name that matches the edited character string has been searched by the search module 142 and if it is determined by the determination module 140, that the character string that has not been edited is similar to the edited character string, the registration module 1339 sends, to the conversion server 1400, a registration request indicating that the character string that has not been edited and the edited character string are to be registered in the conversion DB 1410. Consequently, the conversion server 1400 sets the received character string that has not been edited as a character string that has not been converted, sets the received edited character string as the converted character string, associates both the character strings, registers the associated character strings in the conversion DB 1410, and sends the completion of the registration to the mobile terminal 1300.

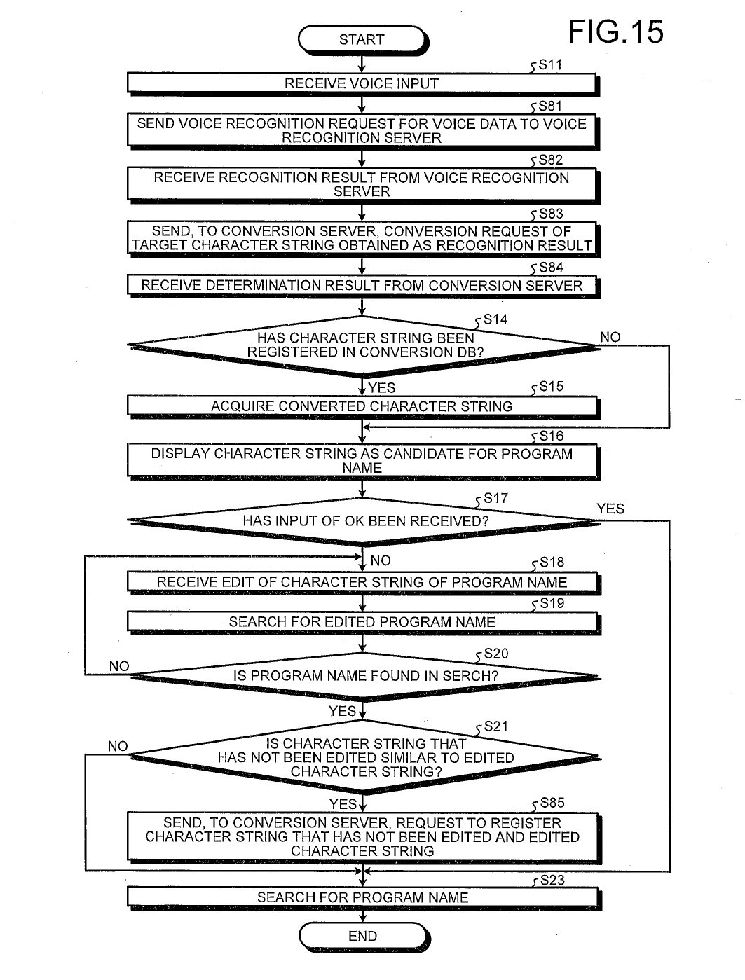

In the following, a program search process according to the fourth embodiment configured in this way will be described with reference to FIG. 15.

Similar to the first embodiment, the voice input module 124 receives a voice input performed by a user (S11). Then, the controller 131 sends a voice recognition request together with voice data of the received voice input to the voice recognition server 1500 via the communication I/F 123 (S81). Then, the controller 131 receives the recognition result from the voice recognition server 1500 (S82).

Then, the conversion module 1335 sends, to the conversion server 1400 via the communication I/F 123, a conversion request of a target character string together with a character string obtained as the recognition result (S83). Then, the conversion module 1335 receives the determination result from the conversion server 1400 via the communication I/F 123 (S84).

Then, the conversion module 1335 determines whether determination result indicates that the sent character string obtained as the recognition result has been registered in the conversion DB 1410 (S14). If the determination result indicates that the sent character string obtained as the recognition result has been registered in the conversion DB 1410 (Yes at S14), the conversion module 1335 acquires a converted character string that is included in the determination result and thus the conversion module 1335 converts the character string (S15). In contrast, at S14, if the determination result indicates that the character string obtained as the recognition result has not been registered in the conversion DB 1410 (No at S14), the process at S15 is not performed. Then, the processes at S16 to S21 are performed in a similar manner as those performed in the first embodiment.

If it is determined, at S21, that the character string that has not been edited is similar to the edited character string (Yes at S21), the registration module 1339 sends, to the conversion server 1400, a request to register the character string that has not been edited and the edited character string in the conversion DB 1410 (S85). Consequently, the conversion server 1400 sets the character string that has not been edited as a character string that has not been converted, sets the edited character string as a converted character string, associates both the character strings, and registers the associated character strings in the conversion DB 1410. If it is determined, at S21, that the character string that has not been edited is not similar to the edited character string (No at S21), the sending process of the registration request at S85 is not performed. Then, the search module 142 performs a program search by using the program name of the edited character string (S23).

As described above, in the fourth embodiment, because voice recognition is performed in the voice recognition server 1500 in a network, the conversion DB 1410 is provided in the conversion server 1400 in the network, and the conversion process of a character string is performed by the conversion server 1400, the same effect as described in the first embodiment can be obtained and, furthermore, the processing load applied on the mobile terminal 1300 side can be reduced.

Modification

Furthermore, in the first to the fourth embodiments, the registration of a character string that has not been converted and a converted character string in the conversion DBs 138 and 1410 is performed in the flow of the program search process; however, the embodiment is not limited thereto. For example, the registration may also be configured such that a character string that is expected to be frequently registered is previously associated with a character string that has been converted from the frequently registered character string and the associated character strings are registered in the conversion DBs 138 and 1410.

Furthermore, in the first to the fourth embodiments, in the conversion DBs 138 and 1410, a character string that has not been converted and a converted character string are registered in a one-to-one relationship; however, the embodiment is not limited thereto. For example, the conversion module 135 and the conversion server 1400 may also be configured to register, for a single character string that has not been converted, a plurality of converted character strings that are different each time and send, as a reply if an access from the mobile terminal 100 or 1300 is detected, a character string converted at the time that is associated with the accessed date and time.

Furthermore, for example, if the conversion DB 1410 is shared in a network as described in the fourth embodiment, the configuration may also be possible such that, for a single character string that has not been converted, a plurality of converted character strings with different expressions is registered and, if a conversion request is received from the mobile terminal 1300, character string converted to a different expression in accordance with the location or the like of the mobile terminal 1300. Namely, when a conversion request is sent from the mobile terminal 1300, location information of the mobile terminal 1300 is also sent and the conversion server 1400 sends, as a response, a character string that has been converted in accordance with the location information.

Furthermore, it may also be possible to configure the conversion server 1400 and the conversion DB 1410 each of which is different for each region. In such a case, for each of the conversion DBs 1410 in a region, for a character string that has not been converted, character strings with different expressions or dialects in accordance with regions are registered as converted character strings. In such a case, the mobile terminal 1300 may be configured to send a conversion request to the conversion server 1400 that is the closest to the current location.

A program search program executed by the mobile terminals 100 and 1300 according to the first to the fourth embodiments are provided by being stored in a computer connected to a network on the Internet or the like, being downloaded via the network, and being installed in the nonvolatile memory 120.

The program search program executed by the mobile terminals 100 and 1300 according to the first to the fourth embodiments may also be configured to be provided in a state of being recorded in a computer readable recording medium, such as a CD-ROM, a flexible disk (FD), a CD-R, a digital versatile disk (DVD), or the like as files with the format that can be installed or that can be executed.

Furthermore, the program search program executed by the mobile terminals 100 and 1300 according to the first to the fourth embodiments may also be provided in a state of being embedded in the nonvolatile memory 120 or the like in advance.

Furthermore, the program search program executed by the mobile terminals 100 and 1300 according to the first to the fourth embodiments may also be configured to be provided or delivered via a network, such as the Internet or the like.

The program search program executed by the mobile terminals 100 and 1300 according to the first to the fourth embodiments has a module configuration comprising each of the modules described above (the controller 131, the input/output control module 132, the voice recognition module 134, the conversion modules 135 and 1335, the command generator 137, the edit module 141, the registration modules 139 and 1339, the determination module 140, and the search module 142). As actual hardware, the CPU 116 reads and executes the program search program installed in the nonvolatile memory 120, whereby each of the modules is loaded in the RAM 121. Then, the controller 131, the input/output control module 132, the voice recognition module 134, the conversion modules 135 and 1335, the command generator 137, the edit module 141, the registration modules 139 and 1339, the determination module 140, and the search module 142 are implemented on the RAM 121.

Furthermore, various modules in the system described in the first to the fourth embodiments can be implemented as a software application, a hardware and/or software module, or components in one or more computer, such as a server. The various modules are independently described; however, all or some part of the modules that basically have the same logic or code may also be shared.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method by an electronic device comprising:
receiving audio data including a voice of a user;
performing voice recognition to translate the audio data to text including a first character string corresponding to the voice;
determining whether the first character string is registered in conversion information;
displaying, when the first character string is registered in the conversion information, a second character string associated with the first character string in the conversion information;
receiving, when an instruction is received from the user and when the first character string is not registered in the conversion information, a third character string obtained by editing the first character string; and
registering, when the third character string is found in program information, the third character string in the conversion information so as to associate the third character string with the first character string.

2. The method of claim 1, wherein, when the third character string is found in the program information and when the first character string is similar to the third character string, the registering includes registering the third character string in the conversion information so as to associate the third character string with the first character string.

3. The method of claim 1, wherein
the displaying includes displaying, in a selectable manner, one or a plurality of candidate character strings that are candidates other than the first character string and correspond to the voice, and
when a user selects a character string from among the one or the plurality of the candidate character strings, the registering includes registering the selected character string in the conversion information so as to associate the selected character string with the first character string.

4. The method of claim 1, wherein, after the audio data is received, and when second audio data including a first voice is received within a certain time period, the registering includes registering a character string corresponding to the first voice in the conversion information so as to associate the character string corresponding to the first voice with the first character string corresponding to the voice.

5. The method of claim 1, further comprising:
sending the third character string to the conversion information in a network; and
receiving a determination result, obtained from the conversion information, indicative of whether the third character string has been registered, wherein
when the third character string is found in the program information, the sending includes sending the third character string to the conversion information in the network.

6. An electronic device comprising:
an input controller comprising a microphone configured to receive audio data including a voice of a user and to perform voice recognition of the audio to translate the audio data to text including a first character string corresponding to the voice;
a display configured to display, when the first character string is registered in conversion information, a second character string associated with the first character string in the conversion information;
an edit controller configured to receive, when an instruction is received and when the first character string is not registered in the conversion information, a third character string obtained by editing the first character string; and
a registration controller configured to register, when the third character string is found in program information, the third character string in the conversion information so as to associate the third character string with the first character string.

7. The electronic device of claim 6, wherein, when the third character string is found in the program information and when the first character string is similar to the third character string, the registration controller registers the third character string in the conversion information so as to associate the third character string with the first character string.

8. The electronic device of claim 6, further comprising storage configured to store therein the conversion information.

9. The electronic device of claim 6, wherein
the display displays, in a selectable manner, one or a plurality of candidate character strings that are candidates other than the first character string and correspond to the voice, and
when a user selects a character string from among the one or the plurality of the candidate character strings, the registration controller registers the selected character string in the conversion information so as to associate the selected character string with the first character string.

10. The electronic device of claim 6, wherein, after the audio data is received, and when second audio data including a first voice is received within a certain time period, the registration controller registers a character string corresponding to the first voice in the conversion information so as to associate the character string corresponding to the first voice with the first character string corresponding to the voice.

11. The electronic device of claim 6, further comprising:
a communication controller configured to send the third character string to the conversion information in a network and configured to receive a determination result, obtained from the conversion information, indicative of whether the third character string is registered, wherein
when the third character string is found in the search, the communication controller sends the third character string to the conversion information in the network.

12. A computer program product including programmed instructions embodied in and stored on a non-transitory computer readable medium, wherein the instructions, when executed by a computer, cause the computer to perform:
receiving audio data including a voice of a user;
performing voice recognition translating the audio data to text including a first character string corresponding to the voice;
displaying, when the first character string corresponding to the voice is registered in conversion information, a second character string associated with the first character string in the conversion information;
receiving, when an instruction is received from the user and when the first character string is not registered in the conversion information, a third character string obtained by editing the first character string; and
registering, when the third character string is found in program information, the third character string in the conversion information so as to associate the third character string with the first character string.

13. The computer program product of claim 12, wherein, when the third character string is found in the program information and when the first character string is similar to the third character string, the registering includes registering the third character string in the conversion information so as to associate the third character string with the first character string.

14. The computer program product of claim 12, wherein
the displaying includes displaying, in a selectable manner, one or a plurality of candidate character strings that are candidates other than the first character string and correspond to the voice, and
when the user selects a character string from among the one or the plurality of the candidate character strings, the registering includes registering the selected character string in the conversion information so as to associate the selected character string with the first character string.

15. The computer program product of claim 12, wherein, after the audio data is received, and when second audio data including a first voice of the user is received within a certain time period, the registering includes registering a character string corresponding to the first voice in the conversion information so as to associate the character string corresponding to the first voice with the first character string corresponding to the voice.

16. The computer program product of claim 12, wherein the instructions, when executed by the computer, further causes the computer to perform:
sending the third character string to the conversion information in a network; and
receiving a determination result, obtained from the conversion information, indicative of whether the third character string has been registered, wherein
when the third character string is found in the program information, the sending includes sending the third character string to the conversion information in the network.
